(19) United States
(12) Patent Application Publication
(10) Pub. No.: US 2023/0386237 A1
(43) Pub. Date: Nov. 30, 2023

(54) CLASSIFICATION METHOD AND APPARATUS, ELECTRONIC DEVICE AND STORAGE MEDIUM

(71) Applicant: BEIJING BAIDU NETCOM SCIENCE TECHNOLOGY CO., LTD., Beijing (CN)

(72) Inventors: Chenhui LIU, Beijing (CN); Jian GONG, Beijing (CN); Ke SUN, Beijing (CN); Xu PAN, Beijing (CN); Siqi XU, Beijing (CN); Zecheng ZHUO, Beijing (CN)

(73) Assignee: BEIJING BAIDU NETCOM SCIENCE TECHNOLOGY CO., LTD., Beijing (CN)

(21) Appl. No.: 18/157,377

(22) Filed: Jan. 20, 2023

(30) Foreign Application Priority Data
May 30, 2022 (CN) 202210605666.4

(51) Int. Cl. G06V 30/19

(52) U.S. Cl. CPC G06V 30/19173; G06V 30/19093; G06V 30/1912

(57) ABSTRACT

Provided are a classification method and apparatus, an electronic device and a storage medium, which relate to the field of artificial intelligence and in particular, to the fields of natural language processing and deep learning. The classification method comprises: performing coding processing on to-be-classified data to obtain a to-be-classified coding feature; determining reference coding features of reference classification data similar to the to-be-classified data according to the to-be-classified coding feature; and determining a target category of the to-be-classified data according to the reference coding features and reference categories of the reference classification data.

### CROSS-REFERENCE TO RELATED APPLICATION

This application claims priority to Chinese Patent Application No. CN202210605666.4, filed on May 30, 2022, the disclosure of which is incorporated herein by reference in its entirety.

### TECHNICAL FIELD

The present disclosure relates to the technical field of artificial intelligence, in particular, to the technical fields of natural language processing and deep learning, and for example, to a classification method and apparatus, an electronic device and a storage medium, and for example, can be used in scenarios of smart cities and intelligent cloud.

### BACKGROUND

The development of artificial intelligence and machine learning provides the foundation for intelligence and technological innovation in various industries. In the scenario of data classification, fast data classification by means of artificial intelligence technology and machine learning algorithms is a proven and efficient method.

### SUMMARY

The present disclosure provides a classification method and apparatus, an electronic device and a storage medium.

According to an aspect of the present disclosure, a classification method is provided. The method includes the steps described below.

Coding processing is performed on to-be-classified data to obtain a to-be-classified coding feature.

Reference coding features of reference classification data similar to the to-be-classified data are determined according to the to-be-classified coding feature.

A target category of the to-be-classified data is determined according to the reference coding features and reference categories of the reference classification data.

According to another aspect of the present disclosure, an electronic device is provided. The electronic device includes at least one processor and a memory communicatively connected to the at least one processor.

The memory is configured to store instructions executable by the at least one processor, where the instructions are configured to be executed by the at least one processor to enable the at least one processor to perform any classification method provided by embodiments of the present disclosure.

According to another aspect of the present disclosure, a non-transitory computer-readable storage medium is provided. The storage medium is configured to store computer instructions, where the computer instructions are used for causing a computer to perform any classification method provided by embodiments of the present disclosure.

Through the technical solutions of the present disclosure, the complexity of the classification method is reduced, and the accuracy of data classification is improved.

It is to be understood that the content described in this part is neither intended to identify key or important features of embodiments of the present disclosure nor intended to limit the scope of the present disclosure. Other features of the present disclosure are apparent from the description provided hereinafter.

### BRIEF DESCRIPTION OF DRAWINGS

The drawings are intended to provide a better understanding of the present solution and not to limit the present disclosure. In the drawings:

FIG. 1 is a schematic diagram of a classification method according to an embodiment of the present disclosure;

FIG. 2 is another schematic diagram of a classification method according to an embodiment of the present disclosure;

FIG. 3 is another schematic diagram of a classification method according to an embodiment of the present disclosure;

FIG. 4 is a schematic diagram of a text classification method according to an embodiment of the present disclosure;

FIG. 5 is a structure diagram of a classification apparatus according to an embodiment of the present disclosure; and

FIG. 6 is a block diagram of an electronic device for performing a classification method according to an embodiment of the present disclosure.

### DETAILED DESCRIPTION

Example embodiments of the present disclosure, including details of embodiments of the present disclosure, are described hereinafter in conjunction with the drawings to facilitate understanding. The example embodiments are merely illustrative. Therefore, it is to be appreciated by those of ordinary skill in the art that various changes and modifications may be made to the embodiments described herein without departing from the scope and spirit of the present disclosure. Similarly, the description of well-known functions and constructions is omitted hereinafter for clarity and conciseness.

The classification method and the classification apparatus provided by the embodiments of the present disclosure are applicable to the scenario of classifying to-be-classified data. The classification method provided by the embodiments of the present disclosure may be performed by a classification apparatus. The apparatus may be implemented by software and/or hardware and is configured in an electronic device. The electronic device may be a computer, a server or the like, which is not limited in the present disclosure.

To facilitate understanding, the classification method is described in detail first.

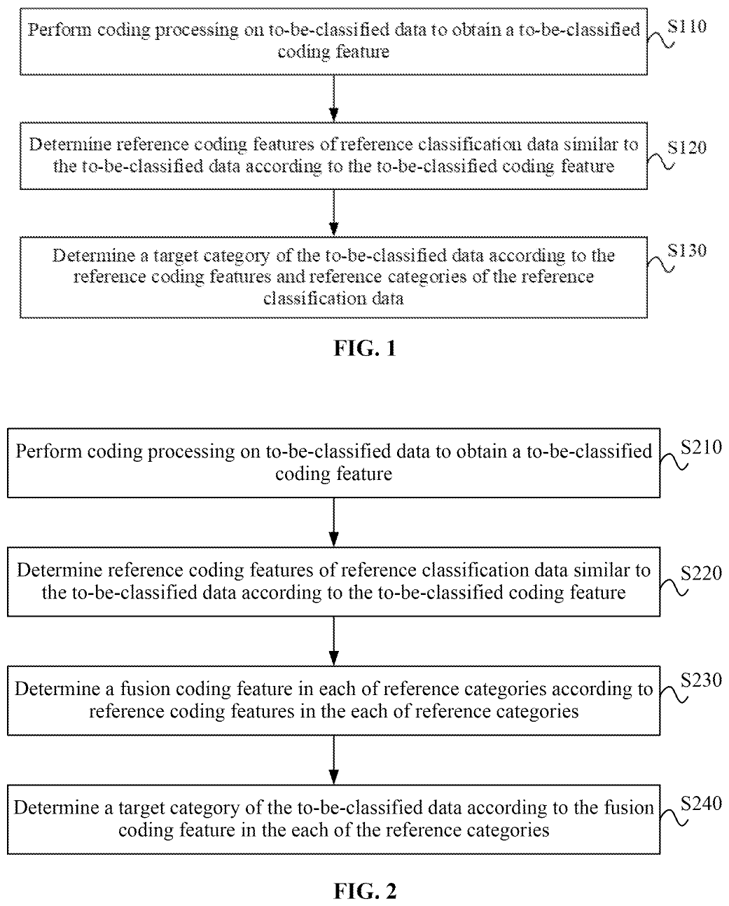

FIG. 1 is a schematic diagram of a classification method according to an embodiment of the present disclosure. As shown in FIG. 1, the method includes steps S110, S120, and S130.

In S110, coding processing is performed on to-be-classified data to obtain a to-be-classified coding feature.

The to-be-classified data is data that needs to be classified. Optionally, the to-be-classified data may include at least one of text data, image data or audio/video data to adapt to application scenarios such as text classification, image classification and audio/video classification. The coding processing may be the process in which the to-be-classified data is subjected to data processing according to a preset coding manner, and the preset coding manner may be set according to manual experience or actual requirements. For example, the coding processing of the text data may be that to-be-classified text data is coded into a text vector through a text vectorization model. Of course, the vectorization coding processing manner is illustrative, and the coding processing is not limited in the embodiments of the present disclosure.

The to-be-classified coding feature may be feature data that is obtained after the to-be-classified data is coded and that includes category characterization information. Since the to-be-classified data may be classified according to different dimensions, to-be-classified coding features involving various classification conditions in different dimensions may be obtained after the to-be-classified data is coded.

For example, taking the coding processing of text data as an example, coding processing is performed on a to-be-classified text through a preset text vectorization model to obtain a to-be-classified text vector corresponding to the to-be-classified text, and the to-be-classified text vector includes feature data that can be used to classify the text data.

In S120, reference coding features of reference classification data similar to the to-be-classified data are determined according to the to-be-classified coding feature.

The reference classification data may be classified data for assisting in the classification of the to-be-classified data. The data type of the reference classification data similar to the to-be-classified data is the same as the data type of the to-be-classified data (for example, the two types of data both belong to text data), and the categories corresponding to the reference classification data similar to the to-be-classified data are known (that is, the reference classification data is pre-classified data that includes category labels). The reference coding features may be feature data obtained after the reference classification data similar to the to-be-classified data is subjected to coding processing, and the reference coding features carry category characterization information of reference classification data of different categories.

It is to be understood that since the categories of the reference classification data are known, the reference coding features may be determined through a preset coding algorithm based on the to-be-classified coding feature and the reference classification data. The preset coding algorithm may be implemented by any coding algorithm in the related art, and the preset coding algorithm is not limited in the embodiments of the present disclosure.

In an optional embodiment, the step where the reference coding features of the reference classification data similar to the to-be-classified data are determined according to the to-be-classified coding feature may include the following steps: the reference classification data similar to the to-be-classified data is recalled from candidate classification data of a preset database according to the to-be-classified coding feature, and coding features of the reference classification data are taken as the reference coding features. Optionally, the volume of the candidate classification data in the preset database is relatively small.

The preset database may be a database storing various candidate classification data. The candidate classification data is used for providing the reference classification data. The reference classification data similar to the to-be-classified data is recalled from the preset database storing candidate classification data. The recalling method may use any recalling algorithm in the related art, and the recalling method is not limited in the embodiments of the present disclosure. The coding features corresponding to the recalled reference classification data are taken as the reference coding features, and apparently, the reference coding features carry category characterization information corresponding to the recalled reference classification data.

Optionally, the reference coding features may be determined by recalling the reference classification data and performing coding processing on the reference classification data to obtain the reference coding features; of course, the reference coding features may be determined by performing coding processing on various candidate classification data in advance to obtain various candidate coding features and performing recalling on the candidate coding features to obtain the reference coding features of the reference classification data similar to the to-be-classified data from the recalled candidate coding features. The manner for determining the reference coding feature is not limited in the embodiments of the present disclosure.

It is to be noted that the volume of the candidate classification data in the preset database is relatively small. It is to be understood that although the processing of a large volume of data increases the number of samples, the processing of a large volume of data is disadvantageous for the classification efficiency and the fast cold start of the classification labels, and therefore, a relatively small volume of candidate classification data is configured in the preset database to solve the problem of the cold start of the classification labels.

In the preceding optional embodiments, the similar reference classification data is recalled, for the to-be-classified data, from the preset database including a relatively small volume of candidate classification data. In the case where the sample size of the candidate classification data is small, the recalling efficiency can be improved, and the problem of the cold start of the classification label can be solved, thereby improving the overall classification efficiency of the to-be-classified data.

In S130, a target category of the to-be-classified data is determined according to the reference coding features and reference categories of the reference classification data.

The reference categories may be the actual category labels corresponding to various parts of the reference category data, and the number of reference categories is at least one. The target category is a prediction category of the to-be-classified data. For example, the target category of the to-be-classified data may be determined by processing category information included in each of the reference coding features and the reference categories of the reference classification data. The processing process may use methods such as comparison, clustering, and similarity calculation, and the used method is not limited in the embodiments of the present disclosure.

With the preceding example of the text data, when the to-be-classified text is classified, a small number of candidate texts of various categories may be selected randomly or according to a preset rule from all text data labelled with categories to construct a support set database (corresponding to the preceding preset database). The preset rule may be set by those skilled in the art according to experience or may be obtained through a large number of trials. In a specific embodiment, the preset rule may be to select a small volume of text data from each of all text categories to construct a support set database which includes all text categories, and the categories of text data in the support set database are labelled accurately. The preset rule is not limited in the present disclosure. Reference texts similar to the to-be-classified text are determined from the support set database according to the similarity of the to-be-classified text and the candidate text of each category; the reference texts are coded to obtain reference text vectors; and a target category of the to-be-classified text is determined according to the similarity between a to-be-classified text vector and each of the reference text vectors.

In the technical solution of this embodiment of the present disclosure, coding processing is performed on the to-be-classified data to obtain a to-be-classified coding feature that can be used for category determination, and the target category is determined according to the to-be-classified coding feature without complex feature extraction and deep mining. Therefore, the complexity of the classification method is reduced, and the data calculation amount is reduced. In addition, in the preceding technical solution, the reference coding features of the similar reference classification data are determined according to the to-be-classified coding feature, and the target category is determined in conjunction with the reference categories of the reference classification data. With the introduction of the reference coding features and the corresponding reference categories, a rich reference basis is provided for the determination of the target category, thereby further improving the accuracy of the classification method.

FIG. 2 is another schematic diagram of a classification method according to an embodiment of the present disclosure. On the basis of the preceding technical solutions, the present disclosure further provides an optional embodiment. In this optional embodiment, the determination operation of the target category is further refined to improve the accuracy of data classification. It is to be noted that for parts not described in detail in this embodiment of the present disclosure, reference may be made to the related description of the preceding embodiments, and details will not be repeated herein.

The classification method as shown in FIG. 2 includes steps S210, S220, S230, and S240.

In S210, coding processing is performed on to-be-classified data to obtain a to-be-classified coding feature.

In S220, reference coding features of reference classification data similar to the to-be-classified data are determined according to the to-be-classified coding feature.

In S230, a fusion coding feature in each of reference categories is determined according to reference coding features in the each of reference categories.

The fusion coding feature may be a fusion result of different reference coding features in the same reference category. The fusion coding feature may reflect the category characterization information corresponding to the reference category to a large extent, thereby improving the richness and comprehensiveness of the carried information. The fusion method of reference coding features may be any feature fusion algorithm in the related art, and the feature fusion method is not limited in the embodiments of the present disclosure.

It is to be noted that the reference classification data of at least two reference categories may be determined in S220, and feature fusion is performed on the reference classification data of each of different reference categories separately to obtain the fusion coding feature corresponding to the each of the reference categories so that the fusion coding feature can represent the category information of the to-be-classified data from the perspective of the common feature dimension of the reference classification data corresponding to the each of reference categories.

In an optional embodiment, the step where the fusion coding feature in the each of the reference categories is determined according to the reference coding features in the each of reference categories may include the following step: superposition fusion is performed on the reference coding features in the each of reference categories to obtain the fusion coding feature in the each of the reference categories.

The reference coding features in the each of reference categories are fused in the superposition fusion manner to determine the fusion coding feature in the each of the reference categories. The superposition fusion may be performed by pixel-by-pixel superposition or may be implemented using an attention pooling algorithm. When the reference coding features are fused using the superposition fusion manner, the operation is convenient, and the algorithm is simplified so that the volume of operational data of feature fusion is small, thereby reducing the difficulty of feature fusion and improving the classification efficiency.

In an optional embodiment, the step where superposition fusion is performed on the reference coding features in the each of reference categories to obtain the fusion coding feature in the each of the reference categories may include the following steps: for any reference category of the reference categories, a reference similarity between each of reference coding features in the reference category and the to-be-classified coding feature is determined, an attention weight is determined according to each reference similarity in the reference category, and superposition fusion is performed on the reference coding features in the reference category according to the attention weight to obtain a fusion coding feature in the reference category.

The reference similarity may be a similarity parameter between a reference coding feature in each of the reference categories and the to-be-classified coding feature. For example, a cosine similarity calculation method is used to obtain a cosine similarity between the reference coding feature in each of the reference categories and the to-be-classified coding feature as the reference similarity in the each of the reference categories. The attention weight is used for characterizing the importance of each of different reference coding features in the each of reference categories in feature fusion. The higher the attention weight is, the greater the influence of the category characterization information carried by the reference coding feature on the reference category is; the lower the attention weight is, the less the influence of the category characterization information carried by the reference coding feature on the reference category is.

In the preceding embodiment, the reference similarity between each reference coding feature and the to-be-classified coding feature is introduced to determine the attention weight so that when the fusion coding feature in each reference category is determined based on the attention weight, the reference coding feature with a higher reference similarity can be strengthened and the reference coding feature with a lower reference similarity can be weakened, thereby improving the accuracy and rationality of the fusion coding feature and improving the accuracy of the target category.

In an optional embodiment, the reference similarity of each reference coding feature may be directly taken as the attention weight of each reference coding feature.

Since the numbers of reference coding features included in different reference categories are different and the values of reference similarities corresponding to different reference coding features are also different, the accuracy of feature differences between reference categories is affected if the reference similarity is directly taken as the attention weight for the determination of the fusion coding feature. In order to avoid the occurrence of the preceding problems, in another optional embodiment, the step where the attention weight is determined according to the reference similarity between each of reference coding features in the reference category and the to-be-classified coding feature may include the following step: the reference similarity of each of the reference coding features in the reference category and the to-be-classified coding feature is activated to obtain the attention weight, where the sum of the attention weights corresponding to all the reference coding features in the reference category is 1.

The reference similarity corresponding to each of reference coding features in each of the reference category may be normalized by using a preset activation function to obtain the attention weight corresponding to the each of reference coding features. The preset activation function may be set by those skilled in the art according to requirements or empirical values or may be determined by a large number of trials, as long as the sum of the obtained attention weights in the each of reference categories is 1. In a specific embodiment, the activation function may be a softmax function.

In the preceding embodiment, the attention weight is obtained by activating each reference similarity, and the sum of the attention weights in each reference category is set to 1 so that the dimensionality of the attention weight is unified. In this manner, the subsequent standardization processing of the fusion coding features can be facilitated, and the occurrence of the case where the numerical difference of different fusion coding features is large due to the difference of the dimensionality can be avoided, thereby improving the accuracy of the target category determination result.

In S240, the target category of the to-be-classified data is determined according to the fusion coding feature in the each of the reference categories.

For example, the target category of the to-be-classified data may be determined according to the fusion coding feature corresponding to each of the reference categories and the to-be-classified coding feature of the to-be-classified data.

For example, each fusion coding feature may be compared with the to-be-classified coding feature to determine a fusion coding feature similar to the to-be-classified coding feature, and the reference category to which the similar fusion coding feature belongs is taken as the target category. The degree to which the fusing coding feature is similar to the to-be-classified coding feature may be quantified by the similarity. Optionally, the similarity between the fusion coding feature and the to-be-classified coding feature may be determined in at least one similarity determination manner provided in the related art, and the similarity determination manner is not limited in the embodiments of the present disclosure.

In the technical solution of this embodiment of the present disclosure, the fusion coding feature corresponding to each reference category is determined according to the reference coding features in each reference category, and the fusion coding features are generated according to the dimension of the reference category so that the similarity features in the each of reference categories can be enhanced, thereby improving the difference of the fusion coding features in different reference categories and improving the accuracy of the target category.

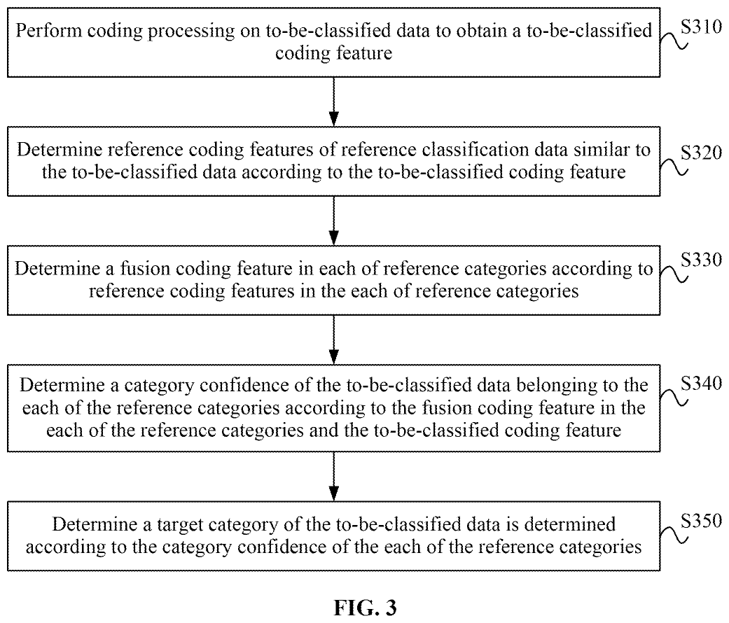

FIG. 3 is another schematic diagram of a classification method according to an embodiment of the present disclosure. On the basis of the preceding technical solutions, the present disclosure further provides an optional embodiment. In this optional embodiment, the determination operation of the target category is further refined to improve the accuracy of data classification. It is to be noted that for parts not described in detail in this embodiment of the present disclosure, reference may be made to the related description of the preceding embodiments, and details will not be repeated herein.

The classification method as shown in FIG. 3 includes steps S210, S320, S330, S340, and S350.

In S310, coding processing is performed on to-be-classified data to obtain a to-be-classified coding feature.

In S320, reference coding features of reference classification data similar to the to-be-classified data are determined according to the to-be-classified coding feature.

In S330, a fusion coding feature in each of reference categories is determined according to reference coding features in the each of reference categories.

In S340, a category confidence of the to-be-classified data belonging to the each of the reference categories is determined according to the fusion coding feature in the each of the reference categories and the to-be-classified coding feature.

It is to be noted that the category confidence reflects the degree of confidence to which the to-be-classified data belongs to the each of the reference categories. It is to be understood that the degrees of confidence to which the to-be-classified data belongs to different reference categories are different; the larger the category confidence is, the greater the possibility that the to-be-classified data belongs to the reference category is, that is, the greater the possibility that the reference category corresponding to the category confidence is determined as the target category is; the smaller the category confidence is, the smaller the possibility that the to-be-classified data belongs to the reference category is, that is, the smaller the possibility that the reference category corresponding to the category confidence is determined as the target category is.

For example, the category confidence of the to-be-classified data belonging to the reference category corresponding to a fusion coding feature may be characterized by the degree of association between the fusion coding feature and the to-be-classified coding feature. The degree of association may be quantified by parameters such as the degree of relevance or the degree of irrelevance.

In an optional embodiment, the step where the category confidence of the to-be-classified data belonging to the each of the reference categories is determined according to the fusion coding feature in the each of the reference categories and the to-be-classified coding feature may include the following steps: a fusion similarity between the fusion coding feature in the each of the reference categories and the to-be-classified coding feature is determined, and the category confidence of the to-be-classified data belonging to the each of the reference categories is determined according to the fusion similarity of the fusion coding feature.

The fusion similarity may be a similarity parameter between the fusion coding feature in the each of the reference categories and the to-be-classified coding feature and characterizes the degree of association between the category of the to-be-classified coding feature and the reference category corresponding to the fusion coding feature. The fusion similarity may be determined through a preset similarity algorithm, such as cosine similarity or Jaccard similarity. The similarity algorithm used in the determination of the fusion similarity is not limited in the present disclosure. Accordingly, the category confidence corresponding to each reference category is determined on the basis of the fusion similarity corresponding to each reference category. For example, the fusion similarity may be directly taken as the category confidence, or the value of the fusion similarity may be processed through a preset algorithm to obtain the corresponding category confidence. The preset algorithm may use any confidence calculation method in the related art. For example, the category confidence is calculated through an activation function (such as a softmax function). The method for determining the category confidence is not limited in the embodiments of the present disclosure.

In the preceding embodiments, based on the fusion coding feature, the fusion similarity is determined from the global perspective of the reference category so that the influence of random factors is avoided, thereby improving the accuracy and rationality of the fusion similarity determination result and improving the accuracy of the category confidence.

In S350, the target category of the to-be-classified data is determined according to the category confidence of the each of the reference categories.

The reference category corresponding to the category confidence meeting a preset condition is selected as the target category according to the category confidence determined in the preceding step. The preset condition may be determined by those skilled in the art according to experience. In an optional embodiment, the preset condition may include at least one of a numerical condition to be satisfied by the category confidence or a quantity condition of the target category.

Optionally, the step where the target category of the to-be-classified data is determined according to the category confidence of the each of the reference categories may include the following step: the target category of the to-be-classified data is determined according to a reference category corresponding to a category confidence with a higher value.

It is to be understood that among the reference categories corresponding to the to-be-classified data, the reference category corresponding to the category confidence with a higher value (for example, the highest value) can best reflect the category information of the to-be-classified data, so the reference category corresponding to the category confidence with a higher value (for example, the highest value) is taken as the target category of the to-be-classified data. Of course, if at least two reference categories with a higher value meet the preset condition, the at least two reference categories may all be determined as the target category, and the number of the determined target categories is not limited in the present disclosure. Taking the reference category corresponding to the category confidence with a higher value as the target category provides a specific and effective method for determining the target category, thereby avoiding the occurrence of classification abnormality caused by too many selected target categories.

In an optional embodiment, the step where the target category of the to-be-classified data is determined according to the category confidence of the each of the reference categories may include the following steps: if a category confidence with the highest value is less than a first preset threshold, the target category of the to-be-classified data is set to a default category, or at least one reference category with a higher category confidence is selected as the target category from reference categories whose category confidence is not less than the first preset threshold, for example, at least one reference category is selected, in an order of category confidence from high to low, as the target category from reference categories whose category confidences are not less than the first preset threshold.

The first preset threshold may be a preset criterion for determining whether a reference category corresponding to a category confidence can be used as the target category. It is to be understood that when the category confidence with the highest data in the reference categories is less than the first preset threshold, it indicates that the degree of association between the to-be-classified data and each reference category is low so that all the reference categories are not suitable as the target category of the to-be-classified data. Therefore, the target category of the to-be-classified data may be set to a default category, and the default category is distinguished from each reference category. Of course, when the category confidence is not less than the first preset threshold, the category confidence corresponding to the reference category may be taken as the target category. The advantage of the preceding setting is that the occurrence of target category labelling errors can be avoided, laying a foundation for dealing with other categories that do not belong to the current classification system (that is, the system constructed by using the reference categories of the reference classification data) in the classification process.

Optionally, after the classification is completed, the to-be-classified data labelled with the default category may be manually labelled to further accurately determine the category to which the to-be-classified data belongs.

In the process of determining the target category directly by using the preceding method, the accuracy of the determined target category becomes low due to the insufficient volume of recalled reference classification data or the influence of other factors. Therefore, a certain compensation mechanism may be introduced to re-determine the target category with low accuracy.

In an optional embodiment, the step where the target category of the to-be-classified data is determined according to the category confidence of the each of the reference categories may include the following step: if a category confidence of the target category is less than a second preset threshold, the target category is determined as a non-confidence category, where the second preset threshold is greater than the first preset threshold.

The second preset threshold may be a preset threshold for determining the degree of reliability of the category confidence. The second preset threshold is set besides the first preset threshold, and the target category is set to a non-confidence category in the case where the category confidence of the target category is less than the second preset threshold so that the basic guarantee for the accuracy of the data classification process is provided with the introduction of the second preset threshold. That is, even if the value of a certain category confidence exceeds the first preset threshold, the category confidence cannot be determined as a reliable target category as long as the value of the category confidence does not exceed the second preset threshold, and the target category needs to be determined by other means such as manual labelling. For example, the first preset threshold is set to 0.4, and the second preset threshold is set to 0.6. If the value of a certain category confidence is 0.5, the reference category corresponding to the category confidence may be determined as a non-confidence category.

In the preceding embodiments, double thresholds are introduced to determine the target category so that a reference category with high reliability is selected as the target category, thereby avoiding the occurrence of classification labelling errors and improving the accuracy of the classification method.

In the technical solution of this embodiment of the present disclosure, based on the fusion coding feature, the fusion similarity is determined from the global perspective of the reference category so that the influence of random factors is avoided, thereby improving the accuracy and rationality of the fusion similarity determination result, improving the accuracy of the determination of the category confidence, and providing a strong support for the subsequent determination of the target category.

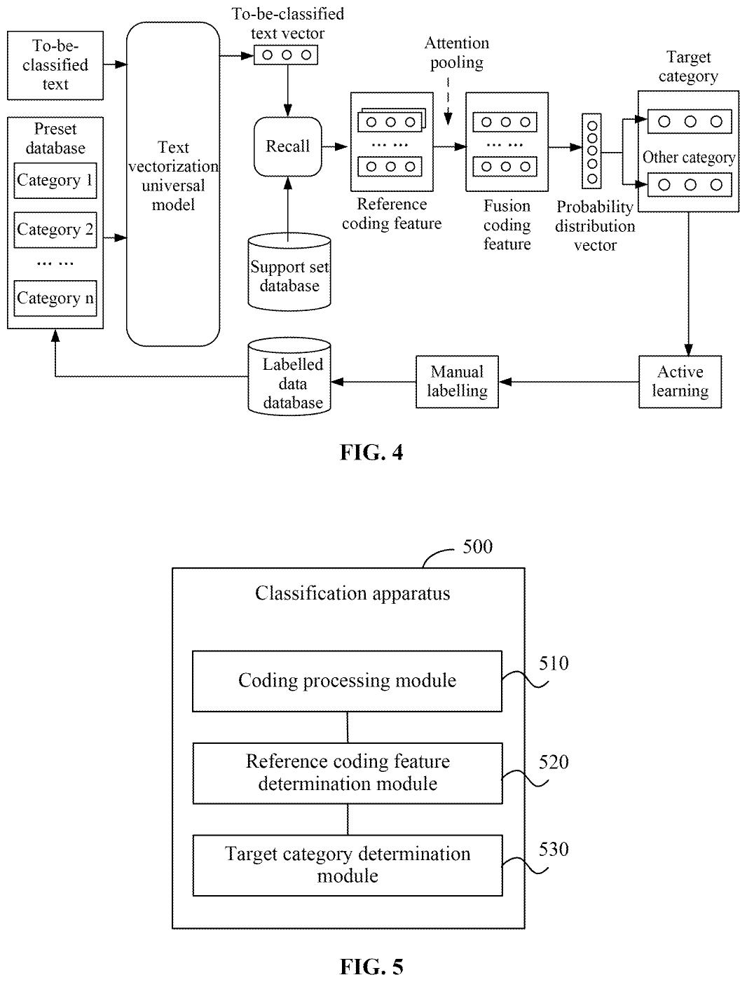

On the basis of the technical solutions of the preceding embodiments, in the scenario of text data classification, the present disclosure further provides a preferred embodiment. The text classification method as shown in FIG. 4 is described as follows.

Coding processing is performed on a to-be-classified text based on a text vectorization universal model to obtain a to-be-classified text vector.

The labelled data database is a database storing all text data labelled with text categories. The preset database is a subset of the labelled data database and includes category-labelled text data of different categories (the number of illustrated categories is n). The text data of each category in the preset database is coded through the preceding text vectorization universal model to obtain reference text vectors, and the reference text vectors are stored in a support set database.

K reference text vectors similar to the to-be-classified text is recalled as reference coding features, for the to-be-classified text vector, from the support set database through the cosine similarity algorithm. The K reference coding features belong to N (N≤n) categories, respectively, and the K reference coding features are divided into N reference groups according to the category dimension.

For each reference group, a cosine similarity between each reference coding feature in a reference group and the to-be-classified text vector is determined, and the cosine similarities in the reference group are normalized based on a preset activation function (such as a softmax function) to obtain an attention weight of each reference coding feature in the reference group. Weight fusion is performed on reference coding features in the reference group based on an attention pooling mechanism, that is, according to the attention weight of each reference coding feature in the reference group, to obtain the fusion coding feature of the reference group.

Further, the cosine similarity between the to-be-classified text vector and the fusion coding feature is calculated. N cosine similarities are combined to obtain a logit vector with the dimension of N. The logit vector is activated through a preset activation function (such as a softmax function) to obtain a probability distribution vector with the dimension of N. Each element in the probability distribution vector may represent the confidence that the to-be-classified text belongs to the labelled text category corresponding to the fusion coding feature. The higher the value of the confidence is, the higher the probability that the to-be-classified text belongs to the text category corresponding to the confidence is.

Further, after the screening based on a preset confidence threshold, target categories that meet the preset confidence threshold and default categories that do not meet the preset confidence threshold are obtained. It is to be understood that the out-of-domain (OOD) problem of the target category can be solved by setting the default categories. The default categories may be set to “other” categories. It is to be understood that the target categories are the determined text categories to which the to-be-classified text belongs. Due to the limited number of recalled reference coding features, the classification of target categories may be inaccurate. At this point, non-confidence categories need to be screened out from the target categories, and the category determination needs to be performed using other methods (such as manual labelling). Therefore, an active learning mechanism (such as an uncertainty sampling algorithm) may be introduced. One uncertainty threshold may be preset, the magnitude of each element (that is, each confidence) in the probability distribution vector is compared with the uncertainty threshold according to the preceding probability distribution vector, and the categories whose confidence is less than the uncertainty threshold may be defined as the non-confidence categories. The to-be-classified texts corresponding to the default category and the non-confidence category may be labelled manually, and the labelled to-be-classified texts may be added to the labelling data database.

FIG. 5 is a structure diagram of a classification apparatus according to an embodiment of the present disclosure. The classification apparatus 500 as shown in FIG. 5 may include a coding processing module 510, a reference coding feature determination module 520, and a target category determination module 530.

The coding processing module 510 is configured to perform coding processing on to-be-classified data to obtain a to-be-classified coding feature.

The reference coding feature determination module 520 is configured to determine reference coding features of reference classification data similar to the to-be-classified data according to the to-be-classified coding feature.

The target category determination module 530 is configured to determine a target category of the to-be-classified data according to the reference coding features and reference categories of the reference classification data.

In the technical solution of this embodiment of the present disclosure, coding processing is performed on the to-be-classified data to obtain a to-be-classified coding feature that can be used for category determination, and the target category is determined according to the to-be-classified coding feature, thereby reducing the complexity of the classification method; the reference coding features of the similar reference classification data are determined through the to-be-classified coding feature, the target classification is determined in conjunction with the reference categories corresponding to the reference classification data, and in this manner, with the introduction of reference coding features and the corresponding reference categories, the basis and assistance are provided for the determination of the target category, thereby improving the accuracy of the classification method.

In an optional embodiment, the target category determination module 530 may include a fusion coding feature determination unit and a target category decision unit.

The fusion coding feature determination unit is configured to determine, according to reference coding features in the each of reference categories, a fusion coding feature in the each of the reference categories.

The target category decision unit is configured to determine the target category of the to-be-classified data according to the fusion coding feature in the each of the reference categories.

In an optional implementation, the fusion coding feature determination unit may be configured to: perform superposition fusion on the reference coding features in the each of reference categories to obtain the fusion coding feature in the each of the reference categories.

In an optional embodiment, the fusion coding feature determination unit may include a reference similarity determination sub-unit, an attention weight determination sub-unit, and a feature superposition fusion sub-unit.

The reference similarity determination sub-unit is configured to, for any reference category of the reference categories, determine a reference similarity between each of reference coding features in the reference category and the to-be-classified coding feature.

The attention weight determination unit is configured to determine an attention weight according to each reference similarity in the reference category.

The feature superposition fusion sub-unit is configured to perform superposition fusion on the reference coding features in the reference category according to the attention weight to obtain a fusion coding feature in the reference category.

In an optional embodiment, the target category decision unit may include a category confidence determination sub-unit and a target category determination sub-unit.

The category confidence determination sub-unit is configured to determine, according to the fusion coding feature in the each of the reference categories and the to-be-classified coding feature, a category confidence of the to-be-classified data belonging to the each of the reference categories.

The target category determination sub-unit is configured to determine the target category of the to-be-classified data according to the category confidence of the each of the reference categories.

In an optional embodiment, the category confidence determination sub-unit may include a fusion similarity determination slave unit and a category confidence determination slave unit.

The fusion similarity determination slave unit is configured to determine a fusion similarity between the fusion coding feature in the each of the reference categories and the to-be-classified coding feature.

The category confidence determination slave unit is configured to determine, according to the fusion similarity of the fusion coding feature, the category confidence of the to-be-classified data belonging to the each of the reference categories.

In an optional embodiment, the category confidence determination sub-unit may include a default category slave unit and a category selection slave unit.

The default category slave unit is configured to, if a category confidence with the highest value is less than a first preset threshold, set the target category of the to-be-classified data to a default category.

The category selection slave unit is configured to select at least one reference category with a higher category confidence as the target category from reference categories whose category confidence is not less than the first preset threshold, for example, at least one reference category is selected, in an order of category confidence from high to low, as the target category from reference categories whose category confidences are not less than the first preset threshold. In an optional embodiment, the target category determination sub-unit may be configured to: if a category confidence of the target category is less than a second preset threshold, determine the target category as a non-confidence category, where the second preset threshold is greater than the first preset threshold.

In an optional embodiment, the reference coding feature determination module 520 may include a reference classification data recalling unit and a reference coding feature determination unit.

The reference classification data recalling unit is configured to recall the reference classification data similar to the to-be-classified data from candidate classification data of a preset database according to the to-be-classified coding feature.

The reference coding feature determination unit is configured to take coding features of the reference classification data as the reference coding features.

The volume of the candidate classification data in the preset database is relatively small.

In an optional embodiment, the to-be-classified data may include at least one of text data, image data or audio-video data.

The preceding classification apparatus may perform the classification method provided by any one of embodiments of the present disclosure and has corresponding functional modules and beneficial effects corresponding to the executed method.

In the technical solutions of the present disclosure, the collection, storage, use, processing, transmission, provision, and disclosure of to-be-classified data and reference classification data involved are in compliance with provisions of relevant laws and regulations and do not violate public order and good customs.

According to an embodiment of the present disclosure, the present disclosure further provides an electronic device, a readable storage medium and a computer program product.

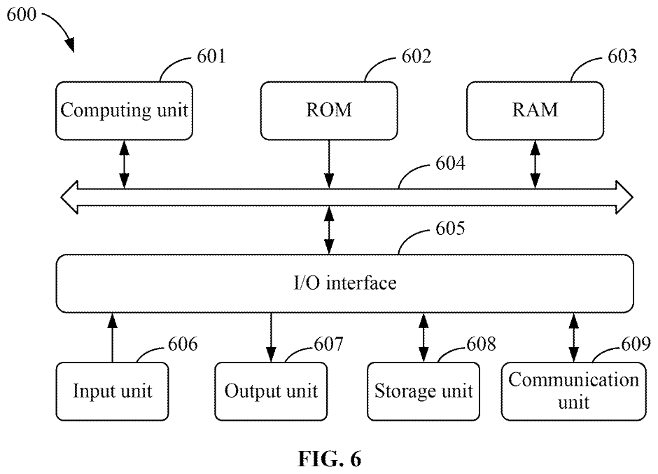

FIG. 6 is an example block diagram of an example electronic device 600 that may be used for performing the embodiments of the present disclosure. The electronic device is intended to represent various forms of digital computers, for example, a laptop computer, a desktop computer, a workbench, a personal digital assistant, a server, a blade server, a mainframe computer, or another applicable computer. The electronic device may also represent various forms of mobile apparatuses, for example, a personal digital assistant, a cellphone, a smartphone, a wearable device, or a similar computing apparatus. Herein the shown components, the connections and relationships between these components, and the functions of these components are illustrative only and are not intended to limit the implementation of the present disclosure as described and/or claimed herein.

As shown in FIG. 6, the device 600 includes a computing unit 601. The computing unit 601 may perform various types of appropriate operations and processing based on a computer program stored in a read-only memory (ROM) 602 or a computer program loaded from a storage unit 608 to a random-access memory (RAM) 603. Various programs and data required for the operation of the device 600 may also be stored in the RAM 603. The computing unit 601, the ROM 602 and the RAM 603 are connected to each other via a bus 604. An input/output (I/O) interface 605 is also connected to the bus 604.

Multiple components in the device 600 are connected to the I/O interface 605. The multiple components include an input unit 606 such as a keyboard or a mouse, an output unit 607 such as various types of displays or speakers, the storage unit 608 such as a magnetic disk or an optical disc, and a communication unit 609 such as a network card, a modem or a wireless communication transceiver. The communication unit 609 allows the device 600 to exchange information/data with other devices over a computer network such as the Internet and/or various telecommunications networks.

The computing unit 601 may be various general-purpose and/or special-purpose processing components having processing and computing capabilities. Some examples of the computing unit 601 include, but are not limited to, central processing units (CPUs), graphics processing units (GPUs), various special-purpose artificial intelligence (AI) computing chips, various computing units running machine learning models and algorithms, digital signal processors (DSPs), and any suitable processors, controllers and microcontrollers. The computing unit 601 performs various methods and processing described above, such as the classification method. For example, in some embodiments, the classification method may be implemented as a computer software program tangibly contained in a machine-readable medium such as the storage unit 608. In some embodiments, part or all of computer programs may be loaded and/or installed on the device 600 via the ROM 602 and/or the communication unit 609. When the computer program is loaded to the RAM 603 and executed by the computing unit 601, one or more steps of the preceding classification method may be performed. Alternatively, in other embodiments, the computing unit 601 may be configured, in any other suitable manner (for example, by means of firmware), to perform the classification method.

Herein various embodiments of the preceding systems and techniques may be implemented in digital electronic circuitry, integrated circuitry, field-programmable gate arrays (FPGAs), application-specific integrated circuits (ASICs), application-specific standard products (ASSPs), systems on chips (SoCs), complex programmable logic devices (CPLDs), computer hardware, firmware, software, and/or combinations thereof. The embodiments may include implementations in one or more computer programs. The one or more computer programs are executable and/or interpretable on a programmable system including at least one programmable processor. The programmable processor may be a special-purpose or general-purpose programmable processor for receiving data and instructions from a memory system, at least one input apparatus and at least one output apparatus and transmitting the data and instructions to the memory system, the at least one input apparatus and the at least one output apparatus.

Program codes for the implementation of the methods of the present disclosure may be written in one programming language or any combination of multiple programming languages. The program codes may be provided for the processor or controller of a general-purpose computer, a special-purpose computer or another programmable data processing apparatus to enable functions/operations specified in flowcharts and/or block diagrams to be implemented when the program codes are executed by the processor or controller. The program codes may be executed entirely on a machine or may be executed partly on a machine. As a stand-alone software package, the program codes may be executed partly on a machine and partly on a remote machine or may be executed entirely on a remote machine or a server.

In the context of the present disclosure, the machine-readable medium may be a tangible medium that may include or store a program for use by or in conjunction with an instruction execution system, apparatus or device. The machine-readable medium may be a machine-readable signal medium or a machine-readable storage medium. The machine-readable medium may include, but is not limited to, an electronic, magnetic, optical, electromagnetic, infrared or semiconductor system, apparatus or device, or any suitable combination thereof. More specific examples of the machine-readable storage medium may include an electrical connection based on one or more wires, a portable computer disk, a hard disk, a random-access memory (RAM), a read-only memory (ROM), an erasable programmable read-only memory (EPROM, or a flash memory), an optical fiber, a portable compact disk read-only memory (CD-ROM), an optical memory device, a magnetic memory device, or any suitable combination thereof.

In order to provide the interaction with a user, the systems and techniques described herein may be implemented on a computer. The computer has a display device (for example, a cathode-ray tube (CRT) or a liquid-crystal display (LCD) monitor) for displaying information to the user and a keyboard and a pointing device (for example, a mouse or a trackball) through which the user can provide input for the computer. Other types of apparatuses may also be used for providing interaction with a user. For example, feedback provided for the user may be sensory feedback in any form (for example, visual feedback, auditory feedback, or haptic feedback). Moreover, input from the user may be received in any form (including acoustic input, voice input, or haptic input).

The systems and techniques described herein may be implemented in a computing system including a back-end component (for example, a data server), a computing system including a middleware component (for example, an application server), a computing system including a front-end component (for example, a client computer having a graphical user interface or a web browser through which a user can interact with implementations of the systems and techniques described herein), or a computing system including any combination of such back-end, middleware or front-end components. Components of a system may be interconnected by any form or medium of digital data communication (for example, a communication network). Examples of the communication network include a local area network (LAN), a wide area network (WAN) and the Internet.

A computing system may include a client and a server. The client and the server are usually far away from each other and generally interact through the communication network. The relationship between the client and the server arises by virtue of computer programs running on respective computers and having a client-server relationship with each other. The server may be a cloud server, also referred to as a cloud computing server or a cloud host. As a host product in a cloud computing service system, the server solves the defects of difficult management and weak service scalability in a related physical host and a related VPS service. The server may also be a server of a distributed system or a server combined with a blockchain.

Artificial intelligence is the study of making computers simulate certain human thinking processes and intelligent behaviors (such as learning, reasoning, thinking and planning), including technologies at both the hardware and software levels. Artificial intelligence hardware technologies generally include technologies such as sensors, special-purpose artificial intelligence chips, cloud computing, distributed storage and big data processing. Artificial intelligence software technologies mainly include several major technologies such as computer vision technology, speech recognition technology, natural language processing technology, machine learning/deep learning technology, big data processing technology and knowledge graph technology.

Cloud computing refers to a technical system that accesses a flexible and scalable shared physical or virtual resource pool through a network, where resources may include servers, operating systems, networks, software, applications and storage devices, and may deploy and manage resources in an on-demand and self-service manner. Cloud computing can provide efficient and powerful data processing capabilities for artificial intelligence, the blockchain and other technical applications and model training.

It is to be understood that various forms of the preceding flows may be used with steps reordered, added, or removed. For example, the steps described in the present disclosure may be executed in parallel, in sequence, or in a different order as long as the desired result of the solutions provided in the present disclosure is achieved. The execution sequence of these steps is not limited herein.

The scope of the present disclosure is not limited to the preceding embodiments. It is to be understood by those skilled in the art that various modifications, combinations, subcombinations, and substitutions may be made according to design requirements and other factors. Any modification, equivalent substitution, improvement and the like made within the spirit and principle of the present disclosure falls within the scope of the present disclosure.

What is claimed is:

1. A classification method, comprising:
performing coding processing on to-be-classified data to obtain a to-be-classified coding feature;
determining reference coding features of reference classification data similar to the to-be-classified data according to the to-be-classified coding feature; and
determining a target category of the to-be-classified data according to the reference coding features and reference categories of the reference classification data.

2. The method according to claim 1, wherein the determining a target category of the to-be-classified data according to the reference coding features and reference categories of the reference classification data comprises:
determining, according to reference coding features in each of the reference categories, a fusion coding feature in the each of the reference categories; and
determining the target category of the to-be-classified data according to the fusion coding feature in the each of the reference categories.

3. The method according to claim 2, wherein the determining, according to reference coding features in each of the reference categories, a fusion coding feature in the each of the reference categories comprises:
performing superposition fusion on the reference coding features in the each of reference categories to obtain the fusion coding feature in the each of the reference categories.

4. The method according to claim 3, wherein the performing superposition fusion on the reference coding features in the each of reference categories to obtain the fusion coding feature in the each of the reference categories comprises:
for any reference category of the reference categories, determining a reference similarity between each of reference coding features in the reference category and the to-be-classified coding feature;
determining an attention weight according to each reference similarity in the reference category; and
performing superposition fusion on the reference coding features in the reference category according to the attention weight to obtain a fusion coding feature in the reference category.

5. The method according to claim 2, wherein the determining the target category of the to-be-classified data according to the fusion coding feature in the each of the reference categories comprises:
determining, according to the fusion coding feature in the each of the reference categories and the to-be-classified coding feature, a category confidence of the to-be-classified data belonging to the each of the reference categories; and
determining the target category of the to-be-classified data according to the category confidence of the each of the reference categories.

6. The method according to claim 5, wherein the determining, according to the fusion coding feature in the each of the reference categories and the to-be-classified coding feature, a category confidence of the to-be-classified data belonging to the each of the reference categories comprises:
determining a fusion similarity between the fusion coding feature in the each of the reference categories and the to-be-classified coding feature; and
determining, according to the fusion similarity of the fusion coding feature, the category confidence of the to-be-classified data belonging to the each of the reference categories.

7. The method according to claim 5, wherein the determining the target category of the to-be-classified data according to the category confidence of the each of the reference categories comprises:
in a case where a category confidence with a highest value is less than a first preset threshold, setting the target category of the to-be-classified data to a default category; or
selecting, in an order of category confidence from high to low, at least one reference category as the target category from reference categories whose category confidences are not less than the first preset threshold.

8. The method according to claim 7, wherein the determining the target category of the to-be-classified data according to the category confidence of the each of the reference categories comprises:
in a case where a category confidence of the target category is less than a second preset threshold, determining the target category as a non-confidence category;
wherein the second preset threshold is greater than the first preset threshold.

9. The method according to claim 1, wherein the determining reference coding features of reference classification data similar to the to-be-classified data according to the to-be-classified coding feature comprises:
recalling the reference classification data similar to the to-be-classified data from candidate classification data of a preset database according to the to-be-classified coding feature; and
taking coding features of the reference classification data as the reference coding features.

10. The method according to claim 1, wherein the to-be-classified data comprises at least one of text data, image data or audio-video data.

11. A classification apparatus, comprising:
at least one processor and
a memory communicatively connected to the at least one processor;
wherein the memory stores instructions executable by the at least one processor, wherein the instructions are configured to be executed by the at least one processor to enable the at least one processor to perform the steps in the following modules:
a coding processing module, which is configured to perform coding processing on to-be-classified data to obtain a to-be-classified coding feature;
a reference coding feature determination module, which is configured to determine reference coding features of reference classification data similar to the to-be-classified data according to the to-be-classified coding feature; and
a target category determination module, which is configured to determine a target category of the to-be-classified data according to the reference coding features and reference categories of the reference classification data.

12. The apparatus according to claim 11, wherein the target category determination module comprises:
a fusion coding feature determination unit, which is configured to determine, according to reference coding features each of the reference categories, a fusion coding feature in the each of the reference categories; and
a target category decision unit, which is configured to determine the target category of the to-be-classified data according to the fusion coding feature in the each of the reference categories.

13. The apparatus according to claim 12, wherein the fusion coding feature determination unit is configured to:
perform superposition fusion on the reference coding features in the each of reference categories to obtain the fusion coding feature in the each of the reference categories.

14. The apparatus according to claim 13, wherein the fusion coding feature determination unit comprises:
a reference similarity determination sub-unit, which is configured to, for any reference category of the reference categories, determine a reference similarity between each of reference coding features in the reference category and the to-be-classified coding feature;
an attention weight determination sub-unit, which is configured to determine an attention weight according to each reference similarity in the reference category; and
a feature superposition fusion sub-unit, which is configured to perform superposition fusion on the reference coding features in the reference category according to the attention weight to obtain a fusion coding feature in the reference category.

15. The apparatus according to claim 12, wherein the target category decision unit comprises:
a category confidence determination sub-unit, which is configured to determine, according to the fusion coding feature in the each of the reference categories and the to-be-classified coding feature, a category confidence of the to-be-classified data belonging to the each of the reference categories; and
a target category determination sub-unit, which is configured to determine the target category of the to-be-classified data according to the category confidence of the each of the reference categories.

16. The apparatus according to claim 15, wherein the category confidence determination sub-unit comprises:
a fusion similarity determination slave unit, which is configured to determine a fusion similarity between the fusion coding feature in the each of the reference categories and the to-be-classified coding feature; and
a category confidence determination slave unit, which is configured to determine, according to the fusion similarity of the fusion coding feature, the category confidence of the to-be-classified data belonging to the each of the reference categories.

17. The apparatus according to claim 15, wherein the category confidence determination sub-unit comprises:
a default category slave unit, which is configured to, in a case where a category confidence with a highest value is less than a first preset threshold, set the target category of the to-be-classified data to a default category; and
a category selection slave unit, which is configured to select, in an order of category confidence from high to low, at least one reference category as the target category from reference categories whose category confidences are not less than the first preset threshold.

18. The apparatus according to claim 17, wherein the target category determination sub-unit is configured to: in a case where a category confidence of the target category is less than a second preset threshold, determine the target category as a non-confidence category;
wherein the second preset threshold is greater than the first preset threshold.

19. The apparatus according to claim 11, wherein the reference coding feature determination module comprises:
a reference classification data recalling unit, which is configured to recall the reference classification data similar to the to-be-classified data from candidate classification data of a preset database according to the to-be-classified coding feature; and
a reference coding feature determination unit, which is configured to take coding features of the reference classification data as the reference coding features.

20. A non-transitory computer-readable storage medium storing computer instructions, wherein the computer instructions are used for causing a computer to perform the following steps:
performing coding processing on to-be-classified data to obtain a to-be-classified coding feature;
determining reference coding features of reference classification data similar to the to-be-classified data according to the to-be-classified coding feature; and
determining a target category of the to-be-classified data according to the reference coding features and reference categories of the reference classification data.
